(19) United States
(12) Patent Application Publication
(10) Pub. No.: US 2025/0355867 A1
(43) Pub. Date: Nov. 20, 2025

(54) DATA QUERY METHOD AND APPARATUS, ELECTRONIC DEVICE, AND STORAGE MEDIUM

(71) Applicant: Beijing Zitiao Network Technology Co., Ltd., Beijing (CN)

(72) Inventors: Zhehao WU, Beijing (CN); Xun WANG, Beijing (CN); Wenhao LI, Beijing (CN); Chihang LI, Beijing (CN)

(21) Appl. No.: 18/860,784

(22) PCT Filed: Oct. 24, 2023
(86) PCT No.: PCT/CN2023/126251

§ 371 Date: Jul. 31, 2025

(30) Foreign Application Priority Data
Oct. 28, 2022 (CN) 202211338643.8

(51) Int. Cl. G06F 16/2452; G06F 16/242; G06F 16/2455

(52) U.S. Cl. CPC G06F 16/24526; G06F 16/2423; G06F 16/24556

(57) ABSTRACT

Embodiments of the present disclosure provide a data query method and apparatus, an electronic device, and a storage medium. A data query statement inputted by a user is displayed. The data query statement includes at least one expression field, and the expression field includes a first object field and a second object field that are arranged in sequence, the first object field representing a data object, and the second object field representing a data attribute of the data object. The expression field is used to define a data query dimension of a target business process, and the query statement is used to represent a target query dimension formed by at least one data query dimension. Target data is obtained by responding to the data query statement. The target data is a result of querying business node data of the target business process based on the target query dimension.

### CROSS-REFERENCES TO RELATED APPLICATIONS

The present disclosure is a National Stage of International Application No. PCT/CN2023/126251, filed on Oct. 24, 2023, which claims priority to Chinese Patent Application No. 202211338643.8, filed with the China National Intellectual Property Administration on Oct. 28, 2022 and entitled “DATA QUERY METHOD AND APPARATUS, ELECTRONIC DEVICE, AND STORAGE MEDIUM”. The content of the above applications are incorporated herein by reference in their entireties.

### TECHNICAL FIELD

Embodiments of the present disclosure relate to the technical field of data storage, and in particular, to a data query method and apparatus, an electronic device, and a storage medium.

### BACKGROUND

Data measurement refers to a processing procedure of sampling, aggregating, and visualizing data in a specific data dimension on the basis of existing data. The data measurement technology is widely used in various types of software.

In the prior art, for application software of a project management type, business process data generated in a business procedure needs to be stored, and data measurement needs to be performed on a business process, so as to implement query and display of data in a specific dimension in the business process.

However, in large-scale application software, due to a complex business process and a large number of data dimensions, data query methods in the prior art have problems of low query efficiency and poor flexibility of a query manner.

### SUMMARY

Embodiments of the present disclosure provide a data query method and apparatus, an electronic device, and a storage medium to overcome problems of low query efficiency and poor flexibility of a query manner.

In a first aspect, an embodiment of the present disclosure provides a data query method, including:
displaying a data query statement inputted by a user, where the data query statement includes at least one expression field, and the expression field includes a first object field and a second object field that are arranged in sequence, the first object field representing a data object, and the second object field representing a data attribute of the data object, where the expression field is used to define a data query dimension of a target business process, and the query statement is used to represent a target query dimension formed by at least one data query dimension: and responding to the data query statement to obtain target data, where the target data is a result of querying business node data of the target business process based on the target query dimension.

In a second aspect, an embodiment of the present disclosure provides a data query apparatus, including:
an input module, configured to: display a data query statement inputted by a user, where the data query statement includes at least one expression field, and the expression field includes a first object field and a second object field that are arranged in sequence, the first object field representing a data object, and the second object field representing a data attribute of the data object, where the expression field is used to define a data query dimension of a target business process, and the query statement is used to represent a target query dimension formed by at least one data query dimension: and
a query module, configured to respond to the data query statement to obtain target data, where the target data is a result of querying business node data of the target business process based on the target query dimension.

In a third aspect, an embodiment of the present disclosure provides an electronic device, including:
a processor, and a memory communicatively connected to the processor:
the memory stores computer-execution instructions; and
the processor executes the computer-execution instructions stored in the memory, to implement the data query method according to the first aspect and various possible designs of the first aspect.

In a fourth aspect, an embodiment of the present disclosure provides a computer-readable storage medium storing computer-execution instructions, and when a processor executes the computer-execution instructions, the data query method according to the first aspect and the various possible designs of the first aspect is implemented.

In a fifth aspect, an embodiment of the present disclosure provides a computer program product, including a computer program, and when the computer program is executed by a processor, the data query method according to the first aspect and various possible designs of the first aspect is implemented.

In a sixth aspect, an embodiment of the present disclosure provides a computer program, and when the computer program is executed by a processor, the data query method according to the first aspect and various possible designs of the first aspect is implemented.

### BRIEF DESCRIPTION OF THE DRAWINGS

In order to more clearly describe the technical solutions in the embodiments of the present disclosure or in the prior art, the following briefly introduces the accompanying drawings required for describing the embodiments or the prior art. Apparently, the accompanying drawings in the following description show some embodiments of the present disclosure, and a person of ordinary skill in the art may still derive other drawings from these accompanying drawings without creative efforts.

FIG. 1 is a diagram of an application scenario of a data query method according to an embodiment of the present disclosure.

FIG. 2 is a first schematic flowchart of a data query method according to an embodiment of the present disclosure.

FIG. 3 is a schematic diagram of a target business process according to an embodiment of the present disclosure.

FIG. 4 is a schematic diagram of a second object field according to an embodiment of the present disclosure.

FIG. 5 is a flowchart of specific implementation steps of step S101 in the embodiment shown in FIG. 2.

FIG. 6 is a schematic diagram of an interface for displaying an expression field according to an embodiment of the present disclosure.

FIG. 7 is a schematic diagram of a data chart according to an embodiment of the present disclosure.

FIG. 8 is a second schematic flowchart of a data query method according to an embodiment of the present disclosure.

FIG. 9 is a flowchart of specific implementation steps of step S204 in the embodiment shown in FIG. 8.

FIG. 10 is a flowchart of specific implementation steps of step S2042 in the embodiment shown in FIG. 9.

FIG. 11 is a schematic diagram of a procedure of generating a homogeneous syntax tree according to an embodiment of the present disclosure.

FIG. 12 is a structural block diagram of a data query apparatus according to an embodiment of the present disclosure.

FIG. 13 is a schematic structural diagram of an electronic device according to an embodiment of the present disclosure.

FIG. 14 is a schematic diagram of a hardware structure of an electronic device according to an embodiment of the present disclosure.

### DESCRIPTION OF EMBODIMENTS

To make the objectives, technical solutions, and advantages of the embodiments of the present disclosure clearer, the technical solutions in the embodiments of the present disclosure will be clearly and completely described below with reference to the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

An application scenario of the embodiments of the present disclosure is described below.

FIG. 1 is a diagram of an application scenario of a data query method according to an embodiment of the present disclosure. The data query method provided in the embodiments of the present disclosure may be applied to an application scenario of data query and data visualization display within an application. Specifically, as shown in FIG. 1, the method provided in the embodiments of the present disclosure may be applied to a terminal device. A target application runs in the terminal device. The target application is, for example, software for realizing a project management purpose. More specifically, a software testing project is used as an example. After a user establishes a software testing project through a target application, business process data related to the software testing project is stored inside a cloud server. When the user needs to query data related to the software testing project and visualization display is performed on the terminal device side, the user inputs a data query statement to the terminal device. Then, the terminal device utilizes the data query method provided in the embodiments to send a query instruction to the cloud server. After responding to the query instruction, the cloud server returns target data corresponding to the query instruction to the terminal device and the target data is displayed on the terminal device, so as to realize the purpose of data query and display.

In the prior art, for application software for a project management type, business process data generated in a business procedure needs to be stored, and data measurement needs to be performed on a business process, so as to implement data query and display in a specific dimension in the business process. However, in large-scale application software, business processes are complex, and business process nodes are inconsistent. For example, in a business process of project A, node p1 (for example, an expert review) is included, but in a business process of project B, node p1 is not included. This results in inconsistent data dimensions in different business processes. In the prior art, data in a corresponding data dimension is usually queried for and searched for by using a fixedly-set data parameter provided by the application software, resulting in problems of complex operations, low efficiency of query operations, and poor flexibility of a query manner. The embodiments of the present disclosure provide a data query method to solve the above problems.

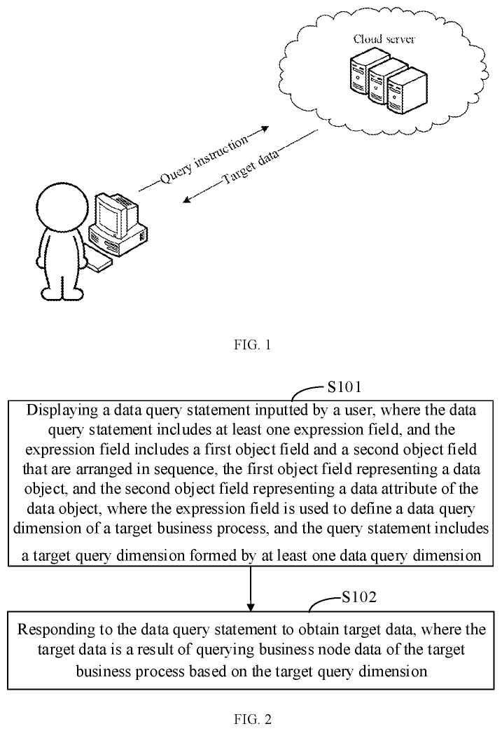

Reference is made to FIG. 2. FIG. 2 is a first schematic flowchart of a data query method according to an embodiment of the present disclosure. The method in this embodiment may be applied to a terminal device. The data query method includes the following steps.

Step S101: displaying a data query statement inputted by a user, where the data query statement includes at least one expression field, and the expression field includes a first object field and a second object field that are arranged in sequence, the first object field representing a data object, and the second object field representing a data attribute of the data object, where the expression field is used to define a data query dimension of a target business process, and the query statement is used to represent a target query dimension formed by at least one data query dimension.

Exemplarily, an execution subject of the method in this embodiment may be a terminal device, such as, a personal computer. The user inputs, through an input device connected to the terminal device (for example, a keyboard), a character string that conforms to a specific syntax rule, that is, the data query statement. More specifically, the data query statement inputted by the user may be received through an input page provided by an application running inside the terminal device, and may be displayed and responded to.

Further, the data query statement includes at least one expression field, that is, the data query statement may be formed by one or more expression fields, and each expression field represents one data query dimension. For example, data query statement A includes [expression field A1], [expression field A2], and [expression field A3]. The data query dimension represented by the expression field A1 is, for example, the number of workers at business node a: the data query dimension represented by the expression field A2 is, for example, the number of workers at business node b; and the data query dimension represented by the expression field A3 is, for example, the number of workers at business node c. The data query statement A=sum (A1, A2, A3) formed by [the expression field A1], [the expression field A2], and [the expression field A3] may represent the total number of workers at the business node a, the business node b, and the business node c.

Further, the expression field includes the first object field and the second object field that are arranged in sequence, where the first object field represents the data object, and the second object field represents the data attribute of the data object.

First, the data object is described. The data object is a data structure, for example, a structure. The data object refers to related data corresponding to a business node in a target business process. For example, the target business process includes business node A, business node B, and business node C. Data corresponding to each business node may be used as a data object, and the data object has a data attribute. More specifically, FIG. 3 is a schematic diagram of a target business process according to an embodiment of the present disclosure. As shown in FIG. 3, for example, the target business process is a project development process, where the project development process includes three sub-task nodes, that is, business node A, business node B, and business node C. The business node A, the business node B, and the business node C are each a data object. The business node A further includes three sub-tasks, that is, business node A1 (shown as A1 in the figure, the same below), business node A2, and business node A3. The business node A1, the business node A2, and the business node A3 of the sub-tasks of the business node A may also be used as data objects. Further, the business node A1, the business node A2, and the business node A3 may respectively have sub-tasks. For example, the business node A1corresponds to business node A11 (shown as A11 in the figure, the same below) and business node A12. For example, the business node A2 corresponds to business node A21, business node A22, and business node A23. The business node A21, the business node A22, and the business node A23 may also be used as data objects. Situations corresponding to the business node B and the business node C are similar thereto and are not described again.

Second, the data attribute is described. The data attribute corresponding to the data object is data that describes related lower-level information of the data object in the form of an attribute. For example, the business node A has two data attributes, namely, data attribute al and data attribute a2, where the data attribute al represents “creation time” of the data object, and the data attribute a2 represents “participants” of the data object. Representation of a data query dimension can be realized through the data object and the corresponding data attribute.

Further, the first object field and the second object field are respectively used to describe the data object and the data attribute. In a possible implementation, the first object field is connected to the second field through a first connection field. Specifically, the first connection field includes a connection symbol, such as, “.” (a dot) or “_” (an underscore), etc. The adjacent first object field and second object field are connected through the first connection field, to identify one data object and the data attribute corresponding to the data object, so as to realize the description of one data query dimension.

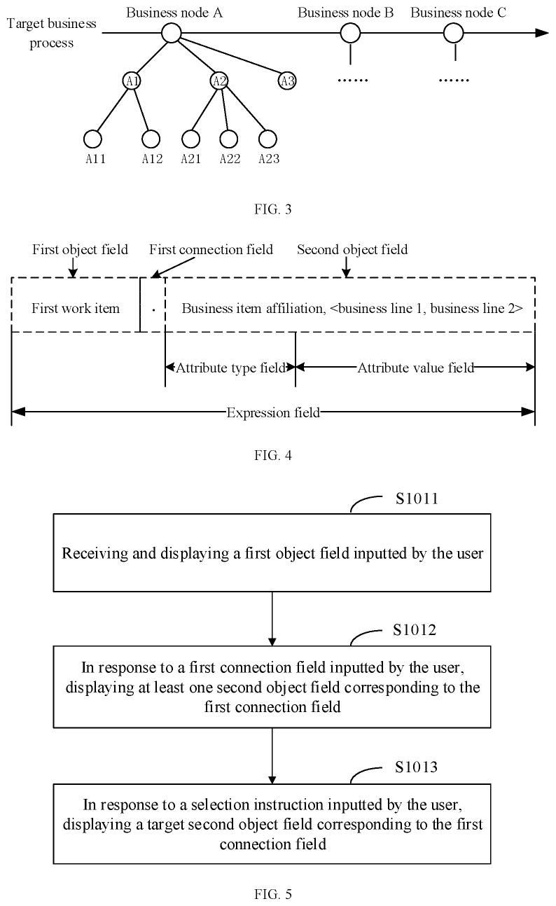

In a possible implementation, the second object field includes an attribute type field and an attribute value field. The attribute type field represents a type of the data attribute, the attribute value field represents an attribute value of the data attribute of a corresponding type, and the attribute type field is connected to the attribute value field through a second connection field. FIG. 4 is a schematic diagram of a second object field according to an embodiment of the present disclosure. As shown in FIG. 4, an attribute type field in a second object field is “business line affiliation”, and a corresponding attribute value field includes two fields, namely, “business line 1” and “business line 2”. This second object field represents objects whose business line affiliations are the business line 1 and the business line 2. In combination with the first object field, for example, the first object field represents a work item, such as, “a first work item”, and the expression field formed by the first object field, the second object field, and the first connection field between the two represents data whose business line affiliations are the business line 1 and the business line 2, among the first work item, that is, one data query dimension. Query is performed based on this expression field, to obtain data in this data query dimension.

Further, in a possible implementation, as shown in FIG. 5, specific implementation steps of step S101 include the following steps.

Step S1011: receiving and displaying a first object field inputted by the user.

Step S1012: in response to a first connection field inputted by the user, displaying at least one second object field corresponding to the first connection field.

Step S1013: in response to a selection instruction inputted by the user, displaying a target second object field corresponding to the first connection field.

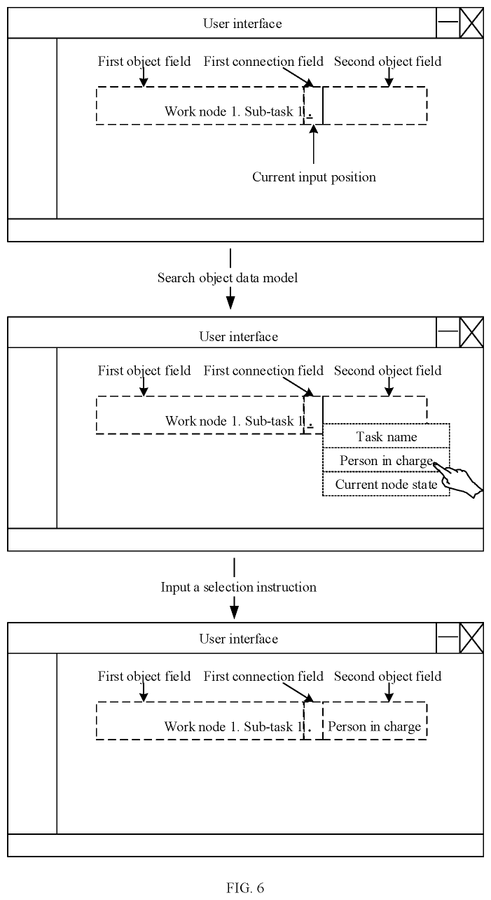

Exemplarily, after the user inputs, through the input device of the terminal device, an instruction representing the first object field to the terminal device, the terminal device receives the instruction, and based on a specific design of a target application, the first object field is displayed within a corresponding interface area in real time. The terminal device synchronously displays content of the instruction inputted by the user, which is the existing technology and is not described again here. Then, when the user continues to input an instruction to the first connection field, the terminal device acquires the second object field that the first object field has, in response to the instruction corresponding to the first connection field, that is, to acquire the data attribute of the data object represented by the first object field. FIG. 6 is a schematic diagram of an interface for displaying an expression field according to an embodiment of the present disclosure. As shown in FIG. 6, within a user interface of the target application, when the user inputs the first object field (shown as “work node 1. sub-task 1” in the figure) and a subsequent first connector (shown as “.” in the figure), that is, a cursor is located at a current input position shown in the figure, in a possible implementation, the terminal device obtains all second object fields corresponding to the first object field by searching data of business nodes of the target business process, and displays the second object fields. With reference to FIG. 6, the terminal device displays three selectable second object fields corresponding to the first object field, which are respectively shown as “task name”, “person in charge”, and “current node state” in the figure. Then, based on a requirement, the user selects one of the displayed second object fields as the target second object field by further inputting the selection instruction.

In this embodiment, through a field structure feature of the expression field in the data query statement, query is performed on the data of the business nodes of the target business process in advance by using a logical relationship between the first object field and the second object fields in a procedure of determining the data query dimension, and the data attributes of the data object represented by the first object field are automatically displayed, so that the user can select the target second object field from the displayed second object fields that the first object field has, thereby accurately and quickly determining the data query dimension and improving interaction efficiency.

Step S102: responding to the data query statement to obtain target data, where the target data is a result of querying business node data of the target business process based on the target query dimension.

Exemplarily, after the data query statement is obtained, the target query dimension is formed by the data query dimension(s) represented by one or more expression fields in the data query statement, and query is performed on the data of the business nodes of the target business process stored in a database based on the target query dimension, to obtain a query result (that is, the target data) that conforms to the target query dimension formed by the one or more data query dimensions. In a possible implementation, the terminal device obtains an object data model and calls the object data model to perform query, so as to obtain the target data. The object data model is a model for storing business node data of structured data, and the business node data is data for business data storage with business nodes as a division dimension in the target business process. The object data model may be a model stored in a cloud server, or a model stored locally on the terminal device. In a possible implementation, after original business data is generated, structured storage is performed in the cloud server, to generate and update the object data model with a specific data structure.

A data structure of the object data model matches an expression manner of the expression field in the data query statement, that is, the object data model also performs data storage for each business node based on a data object and a corresponding data attribute. Therefore, after the data query statement is obtained, data query can be directly performed on the object data model after formula parsing is performed on one or more data expressions in the data query statement, to quickly obtain the target data in the target query dimension represented by the data query statement by searching from the object data model.

In an implementation, after step S102, the method further includes:
step S103: performing visualization rendering based on the target data, and displaying a data chart, where the data chart is used to display a target data object corresponding to the target data and a target data attribute corresponding to the target data object.

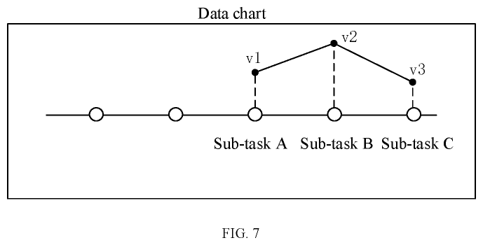

Exemplarily, after the target data is obtained, the target data is the query result based on the target query dimension, and a plurality of data query dimensions corresponding to the target query dimension may be represented in the form of data objects and corresponding data attributes. Therefore, visualization display may be performed with data groups formed by a plurality of groups of data objects and corresponding data attributes, that is, a data chart is displayed. FIG. 7 is a schematic diagram of a data chart according to an embodiment of the present disclosure. Exemplarily, a target query dimension corresponding to target data includes a first query dimension and a second query dimension. A first data object corresponding to the first query dimension represents a sub-task under a target project, and a first data attribute corresponding to the first data object represents that a task state of the sub-task is “uncompleted”. A second data object corresponding to the second query dimension represents a sub-task under the target project, and a second data attribute corresponding to the second data object represents a score of the sub-task. The target data dimension obtained by combining the first query dimension and the second query dimension represents a score of a sub-task whose task state is “uncompleted” under the target project. The data corresponding to the target data dimension is the target data. Then, after visualization rendering is performed on the target data object, the data chart is obtained. In the data chart, sub-tasks whose task states are “uncompleted”, which are represented by the first data object and the first data attribute, are displayed. As shown in FIG. 7, the data chart includes sub-task A, sub-task B, and sub-task C whose task states are “uncompleted”. In addition, scores of the sub-tasks in the “uncompleted” state, which are represented by the second data object and the second data attribute, are as shown in the figure. The data chart includes score v1 corresponding to the sub-task A, score v2 corresponding to the task B, and score v3 corresponding to the task C. In an implementation, the figure may further include connection lines between the scores, to display a change trend of the scores corresponding to the sub-tasks.

In this step of this embodiment, after the target data is obtained, the data chart is generated through the data objects and the data attributes corresponding to the target data and visualization display is performed, and a data structure feature of the target data is fully used to display different data objects and data attributes in the data chart, thereby further increasing display information in the data chart and increasing an information display amount without increasing search calculation overheads.

In this embodiment, the data query statement inputted by the user is displayed. The data query statement includes at least one expression field, and the expression field includes the first object field and the second object field that are arranged in sequence, the first object field representing the data object, and the second object field representing the data attribute of the data object. The expression field is used to define the data query dimension of the target business process, and the query statement is used to represent the target query dimension formed by at least one data query dimension. The target data is obtained by responding to the data query statement. The target data is the result of querying business node data of the target business process based on the target query dimension. Through parsing the data query statement inputted by the user, the data query dimension is represented by a combination representation of the data object and the data attribute, and then the target query dimension is obtained based on a combination of a plurality of data query dimensions. Query is then performed on the business node data in the target business process for the target query dimension, to obtain the corresponding target data, thereby realizing flexible search based on a user instruction, and improving efficient search for business node data in a combined dimension in the business process.

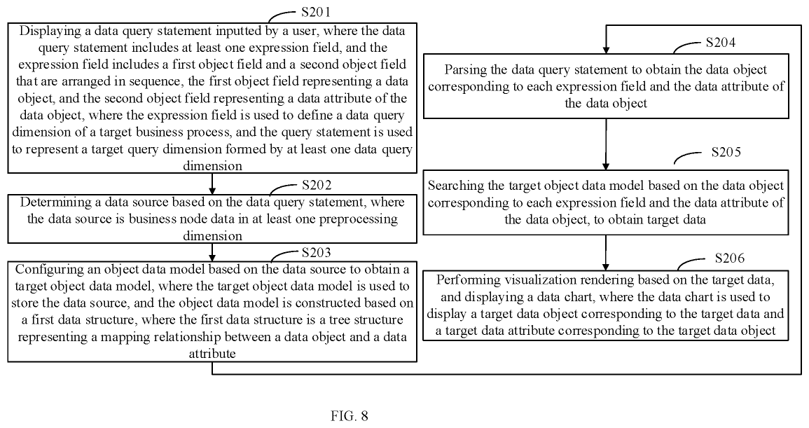

Reference is made to FIG. 8. FIG. 8 is a second schematic flowchart of a data query method according to an embodiment of the present disclosure. Based on the embodiment shown in FIG. 2, this embodiment further refines an implementation procedure of step S102, and adds a step of determining a data source. The data query method includes the following steps.

Step S201: displaying a data query statement inputted by a user, where the data query statement includes at least one expression field, and the expression field includes a first object field and a second object field that are arranged in sequence, the first object field representing a data object, and the second object field representing a data attribute of the data object, where the expression field is used to define a data query dimension of a target business process, and the query statement is used to represent a target query dimension formed by at least one data query dimension.

Step S202: determining a data source based on the data query statement, where the data source is business node data in at least one preprocessing dimension.

Step S203: configuring an object data model based on the data source to obtain a target object data model, where the target object data model is used to store the data source, and the object data model is constructed based on a first data structure, where the first data structure is a tree structure representing a mapping relationship between a data object and a data attribute.

Exemplarily, after the data query statement is obtained, data query will be performed based on this data query statement in subsequent steps. For a large-scale distributed database system, for example, a data storage amount is very large, and full retrieval of data fields corresponding to expression fields in the data query statement will cause long time consumption. Therefore, in this step of this embodiment, after the data query statement is obtained, the corresponding data source may be first obtained, and then the object data model is configured based on the data source to obtain the target object data model including part of data. Then, data search and query are performed based on the target object data model, so that search time consumption can be shortened and search efficiency can be improved.

Specifically, the data source is the business node data in at least one preprocessing dimension. Exemplarily, the preprocessing dimension includes at least one of the following: data time (dimension), a data business type (dimension), etc. More specifically, for example, the data source is data generated in the past 30 days (business node data in the data time dimension), or for example, the data source is data corresponding to a development test business (business node data in the data business type dimension). Further, there are various determination manners for the preprocessing dimension. For example, the preprocessing dimension may be determined by a terminal device based on a user instruction. For another example, the preprocessing dimension may be determined by the terminal device based on a management task currently displayed in a target application. The specific determination manner for the preprocessing dimension may be set as needed, and is not described here again.

Further, the data source obtained based on the preprocessing dimension may be a representation for representing a storage address of the business node data. The target object data model may be obtained by configuring an original object data model based on the data source, where the original object data model may refer to a default object data model for searching full data.

Step S204: parsing the data query statement to obtain the data object corresponding to each expression field and the data attribute of the data object.

Exemplarily, the data query statement is a character string formed by one or more expression fields, where the expression fields are connected through a logical connection field, and the logical connection field represents an intersection operation (an AND operation) or a union operation (an OR operation) of data query dimensions corresponding to the expression fields. Exemplarily, the logical connection field may include a logical operation connector, where the logical operation connector is a symbol representing a logical operation such as an AND operation, an OR operation. More specifically, for example, a symbol “&&” represents an AND operation. The specific implementation of the logical operation connector is not limited to a specific form, and is not described here again.

Then, the data query statement is parsed based on the logical operation connector, as well as the first connection field and the second connection field in each expression field, to obtain the data object corresponding to the expression field and the data attribute of the data object.

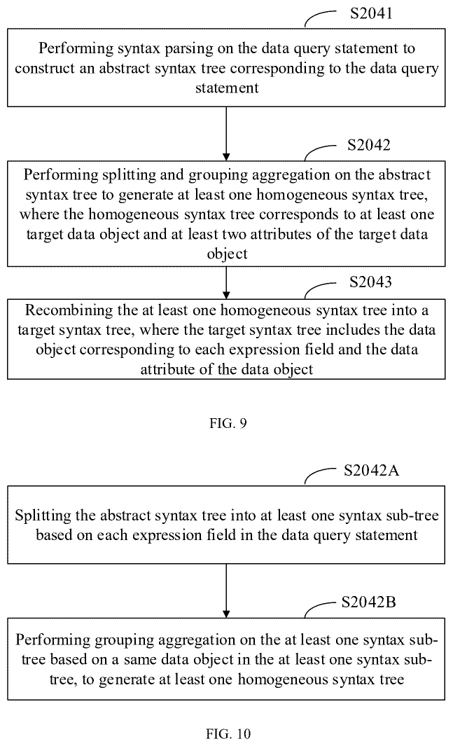

As shown in FIG. 9, exemplarily, specific implementation steps of step S204 include:
step S2041: performing syntax parsing on the data query statement to construct an abstract syntax tree corresponding to the data query statement: and
step S2042: performing splitting and grouping aggregation on the abstract syntax tree to generate at least one homogeneous syntax tree, where the homogeneous syntax tree corresponds to at least one target data object and at least two attributes of the target data object.

Exemplarily, the abstract syntax tree (AST), or a syntax tree for short, is an abstract representation of code syntax structure, and it represents the syntax structure of a language in the form of a tree, where each node on the tree represents a structure in source code. An expression field in the data query statement may be considered as a search syntax, and a data object in the expression field corresponds to a node in the abstract syntax tree. After conversion based on a structure feature of the data object in each expression field, the abstract syntax tree corresponding to the data query statement can be obtained. The abstract syntax tree represents a dimension feature of the target query dimension corresponding to the data query statement in the form of a tree structure.

Further, after the abstract syntax tree is obtained, since the abstract syntax tree is generated by conversion based on the expression fields in the data query statement, the abstract syntax tree includes a plurality of syntax sub-trees, where each syntax sub-tree corresponds to one expression field, and a combination of the sub-trees is the abstract syntax tree.

In a possible implementation, the abstract syntax tree generated based on the data query statement may be directly run to search the object data model to obtain corresponding target data. However, there is a problem of repetitive search for a path in this procedure. For example, in a syntax sub-tree corresponding to expression field A, a data object corresponding to the expression field A is node A12, and thus a search path corresponding to the expression field A is: node A-node A1-node A12: in a syntax sub-tree corresponding to expression field B, a data object corresponding to the expression field A is node A13, and thus a search path corresponding to the expression field A is: node A-node A1-node A13. The syntax sub-tree corresponding to the expression field A and the syntax sub-tree corresponding to the expression field B are separately executed for search, which will result in repetitive search for the path “the node A-the node A1”, leading to a problem of low search efficiency. In the steps of this embodiment of the present disclosure, splitting and grouping aggregation are performed on the abstract syntax tree to generate at least one homogeneous syntax tree corresponding to at least one target data object and at least two attributes of the target data object, and then search is performed based on the homogeneous syntax tree, to avoid repetitive search and improve data search efficiency.

Further, as shown in FIG. 10, exemplarily, specific implementation steps of step S2042 include:
step S2042A: splitting the abstract syntax tree into at least one syntax sub-tree based on each expression field in the data query statement: and
step S2042B: performing grouping aggregation on the at least one syntax sub-tree based on a same data object in the at least one syntax sub-tree, to generate at least one homogeneous syntax tree.

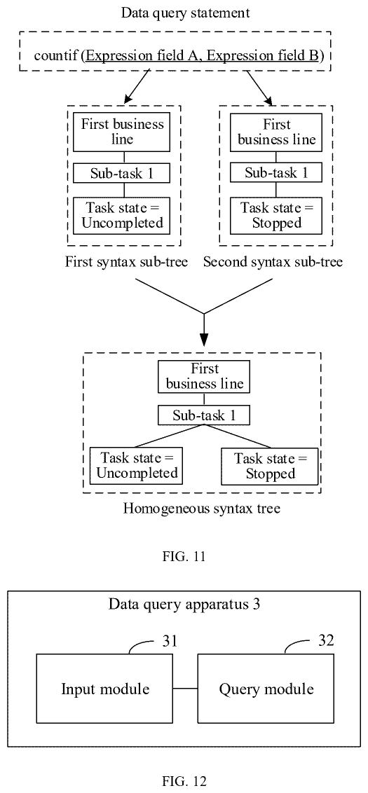

FIG. 11 is a schematic diagram of a procedure of generating a homogeneous syntax tree according to an embodiment of the present disclosure. As shown in FIG. 11, exemplarily, a data query statement includes expression field A and expression field B, as well as a calculation symbol. The calculation symbol is represented as “countif( )”, representing an aggregation function for calculating a total number, that is, an aggregated total number of data query dimensions corresponding to the expression field A and the expression field B. Further, a first object field of the expression field A is “first business line. sub-task 1”, and a second object field of the expression field A is “task state =uncompleted”, representing the number of tasks whose task states are “uncompleted” (data attribute) among the sub-tasks 1 (data object) of the first business line. A first object field of the expression field B is “first business line. sub-task 1”, and a second object field of the expression field B is “task state =stopped”, representing the number of tasks whose task states are “stopped” (data attribute) among the sub-tasks 1 (data object) of the first business line.

Then, a first syntax sub-tree is split out based on the expression field A, and a second syntax sub-tree is split out based on the expression field B. The first syntax sub-tree and the second syntax sub-tree include one same data object, that is, the sub-task 1 of the first business line. Then the first syntax sub-tree and the second syntax sub-tree are aggregated based on the same data object to generate a homogeneous syntax tree.

More specifically, exemplarily, a specific implementation of step S2042B may include:
labeling an aggregation function in each syntax sub-tree: and replacing the corresponding aggregation function based on an auxiliary calculation field, to generate the homogeneous syntax tree, where the auxiliary calculation field is used to map to an expression of the aggregation function. Exemplarily, an operation of each auxiliary calculation field is mapped to a call statement used by the target object data model, for example, a “Group By” clause in an SQL statement.

Exemplarily, the aggregation function in the syntax sub-tree is identified and labeled through the calculation symbol, and then the aggregation function is replaced with the auxiliary calculation field for mapping to the expression of the aggregation function, which is equivalent to abstracting the aggregation function into a global function for the first syntax sub-tree and the second syntax sub-tree. After the corresponding aggregation function is replaced with the auxiliary calculation field, an effect of aggregation for same types can be achieved. In combination with FIG. 11, based on the replacement of the aggregation function, after the homogeneous syntax tree is generated, for repeated data objects, calculation is required only once based on a logic execution sequence of the homogeneous syntax tree. Therefore, search efficiency can be effectively improved, and search time consumption can be reduced.

Step S2043: recombining the at least one homogeneous syntax tree into a target syntax tree, where the target syntax tree includes the data object corresponding to each expression field and the data attribute of the data object.

Exemplarily, after the homogeneous syntax tree with an optimized search path is obtained, the target syntax tree may be generated based on the homogeneous syntax tree. For example, the homogeneous syntax tree is merged with a syntax sub-tree that cannot form the homogeneous syntax tree in the abstract syntax tree, to generate the target syntax tree. If there is no syntax sub-tree that cannot form the homogeneous syntax tree in the abstract syntax tree, the homogeneous syntax tree is directly used as the target syntax tree.

In this step of this embodiment, at least one homogeneous syntax tree corresponding to at least one target data object and at least two attributes of the target data object is generated by splitting and merging for the at least one syntax sub-tree, and then search is performed based on the homogeneous syntax tree, to avoid repetitive search and improve data search efficiency.

Step S205: searching the target object data model based on the data object corresponding to each expression field and the data attribute of the data object, to obtain the target data.

Exemplarily, a specific implementation of step S205 may include: calling corresponding database statements based on the target syntax tree, and searching the target object data model to obtain the target data. After the target syntax tree is obtained, the corresponding database statements are sequentially called based on a logic sequence represented by the target syntax tree to search the target object data model, so as to obtain a search structure corresponding to the target search dimension, that is, the target data. In the previous steps, since the auxiliary calculation field used in a procedure of constructing the target syntax tree is directly mapped to the call statement used by the target object data model, when the target object data model is searched based on the target syntax tree, a corresponding instruction can be directly executed based on the auxiliary calculation field in the target syntax tree, to improve data search efficiency and reduce search time consumption.

Step S206: performing visualization rendering based on the target data, and displaying a data chart, where the data chart is used to display a target data object corresponding to the target data and a target data attribute corresponding to the target data object.

In this embodiment, implementations of step S201 and S206 are the same as the implementations of step S101 and S103 in the embodiment shown in FIG. 2 of the present disclosure, and are not described here again.

Corresponding to the data query method in the foregoing embodiments, FIG. 12 is a structural block diagram of a data query apparatus according to an embodiment of the present disclosure. For ease of description, only parts related to the embodiments of the present disclosure are shown. Referring to FIG. 12, a data query apparatus 3 includes:
an input module 31, configured to: display a data query statement inputted by a user, where the data query statement includes at least one expression field, and the expression field includes a first object field and a second object field that are arranged in sequence, the first object field representing a data object, and the second object field representing a data attribute of the data object, where the expression field is used to define a data query dimension of a target business process, and the query statement is used to represent a target query dimension formed by at least one data query dimension: and
a query module 32, configured to respond to the data query statement to obtain target data, where the target data is a result of querying business node data of the target business process based on the target query dimension.

In an embodiment of the present disclosure, the second object field includes an attribute type field and an attribute value field. The attribute type field represents a type of the data attribute, the attribute value field represents an attribute value of the data attribute of a corresponding type, and the attribute type field is connected to the attribute value field through a second connection field.

In an embodiment of the present disclosure, the first object field is connected to the second object field through a first connection field, and the input module 31 is specifically configured to: receive and display a first object field inputted by the user; in response to a first connection field inputted by the user, display at least one second object field corresponding to the first connection field; and in response to a selection instruction inputted by the user, display a target second object field corresponding to the first connection field.

In an embodiment of the present disclosure, the data query statement further includes a logical connection field, and the logical connection field represents an intersection operation or a union operation of the data query dimension corresponding to the expression field.

In an embodiment of the present disclosure, the query module 32 is specifically configured to: acquire an object data model, where the object data model is used to store data of business nodes of the target business process; and input the data query statement into the object data model to obtain the target data.

In an embodiment of the present disclosure, when inputting the data query statement into the object data model to obtain the target data, the query module 32 is specifically configured to: parse the data query statement to obtain the data object corresponding to each expression field and the data attribute of the data object: and search the object data model based on the data object corresponding to each expression field and the data attribute of the data object, to obtain the target data, where the object data model is constructed based on a first data structure, and the first data structure is a tree structure representing a mapping relationship between a data object and a data attribute.

In an embodiment of the present disclosure, when parsing the data query statement to obtain the data object corresponding to each expression field and the data attribute of the data object, the query module 32 is specifically configured to: perform syntax parsing on the data query statement to construct an abstract syntax tree corresponding to the data query statement: perform splitting and grouping aggregation on the abstract syntax tree to generate at least one homogeneous syntax tree, where the homogeneous syntax tree corresponds to at least one target data object and at least two attributes of the target data object: and recombine the at least one homogeneous syntax tree into a target syntax tree, where the target syntax tree includes the data object corresponding to each expression field and the data attribute of the data object.

In an embodiment of the present disclosure, when searching the object data model based on the data object corresponding to each expression field and the data attribute of the data object, to obtain the target data, the query module 32 is specifically configured to: call a corresponding database statement based on the target syntax tree, and search the object data model to obtain the target data.

In an embodiment of the present disclosure, when performing splitting and grouping aggregation on the abstract syntax tree to generate at least one homogeneous syntax tree, the query module 32 is specifically configured to: split the abstract syntax tree into at least one syntax sub-tree based on each expression field in the data query statement: and perform grouping aggregation on the at least one syntax sub-tree based on a same data object in the at least one syntax sub-tree, to generate at least one homogeneous syntax tree.

In an embodiment of the present disclosure, when performing grouping aggregation on the at least one syntax sub-tree based on the same data object in the at least one syntax sub-tree to generate at least one homogeneous syntax tree, the query module 32 is specifically configured to: label an aggregation function in each syntax sub-tree: and replace the corresponding aggregation function with an auxiliary calculation field to generate the homogeneous syntax tree, where the auxiliary calculation field is used to map to an expression of the aggregation function.

In an embodiment of the present disclosure, before inputting the data query statement into the object data model to obtain the target data, the input module 31 is further configured to: determine a data source based on the data query statement, where the data source is business node data in at least one preprocessing dimension: and configure the object data model based on the data source to obtain a target object data model, where the target object data model is used to store the data source, where the preprocessing dimension includes at least one of the following: data time, a data business type: and the query module 32 is specifically configured to: query the target object data model based on the data query statement to obtain the target data.

In an embodiment of the present disclosure, after the target data is obtained, the query module 32 is further configured to: perform visualization rendering based on the target data, and display a data chart, where the data chart is used to display a target data object corresponding to the target data and a target data attribute corresponding to the target data object.

The input module 31 is connected to the query module 32. The data query apparatus 3 provided in this embodiment may perform technical solutions of the method embodiments described above, and implementation principles and technical effects thereof are similar, and are not described again here in this embodiment.

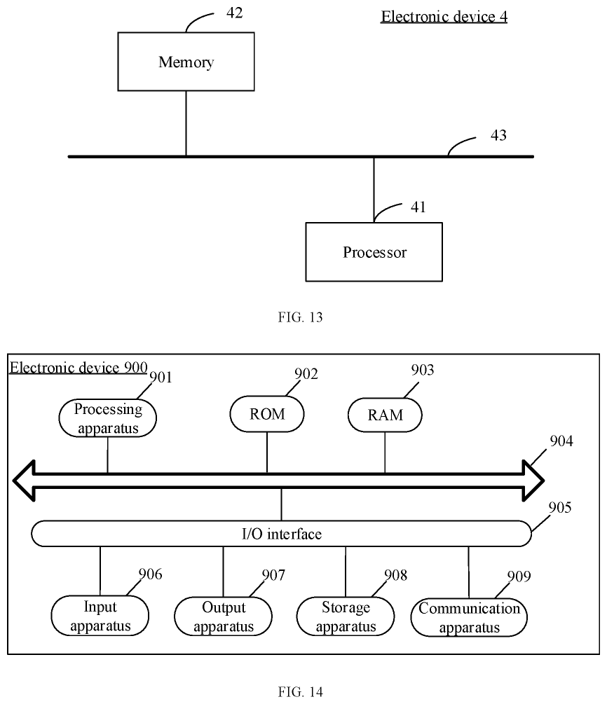

FIG. 13 is a schematic structural diagram of an electronic device according to an embodiment of the present disclosure. As shown in FIG. 13, an electronic device 4 includes:
a processor 41 and a memory 42 communicatively connected to the processor 41:
the memory 42 stores computer-execution instructions; and
the processor 41 executes the computer-execution instructions stored in the memory 42, to implement the data query method in the embodiments shown in FIG. 2 to FIG. 11.

In an implementation, the processor 41 and the memory 42 are connected through a bus 43.

For understanding of related descriptions, reference may be made to related descriptions and effects corresponding to the steps in the embodiments corresponding to FIG. 2 to FIG. 11, which are not described in detail here.

Reference is made to FIG. 14, which shows a schematic structural diagram of an electronic device 900 suitable for implementing the embodiments of the present disclosure. The electronic device 900 may be a terminal device or a server. The terminal device may include, but is not limited to, mobile terminals such as a mobile phone, a notebook computer, a digital broadcast receiver, a personal digital assistant (PDA), a tablet computer (Portable Android Device, PAD), a portable multimedia player (Portable media player, PMP), a vehicle-mounted terminal (such as a vehicle navigation terminal) and the like, and fixed terminals such as a digital TV, a desktop computer and the like. The electronic device 900 shown in FIG. 14 is merely an example, and shall not impose any limitation on the functions and scope of use of the embodiments of the present disclosure.

As shown in FIG. 14, the electronic device 900 may include a processing apparatus (for example, a central processing unit, a graphics processing unit, etc.) 901 that may perform a variety of appropriate actions and processing in accordance with a program stored in a read only memory (ROM) 902 or a program loaded from a storage apparatus 908 into a random access memory (RAM) 903. The RAM 903 further stores various programs and data required for the operation of the electronic device 900. The processing apparatus 901, the ROM 902, and the RAM 903 are connected to each other through a bus 904. An input/output (I/O) interface 905 is also connected to the bus 904.

Generally, the following apparatuses may be connected to the I/O interface 905: an input apparatus 906 including, for example, a touch screen, a touchpad, a keyboard, a mouse, a camera, a microphone, an accelerometer, a gyroscope, etc.: an output apparatus 907 including, for example, a liquid crystal display (LCD), a speaker, a vibrator, etc.: the storage apparatus 908 including, for example, a tape, a hard disk, etc.; and a communication apparatus 909. The communication apparatus 909 may allow the electronic device 900 to perform wireless or wired communication with other devices to exchange data. Although FIG. 14 shows the electronic device 900 having various apparatuses, it should be understood that it is not required to implement or have all the shown apparatuses. It may be an alternative to implement or have more or fewer apparatuses.

In particular, according to embodiments of the present disclosure, the procedures described above with reference to the flowcharts may be implemented as computer software programs. For example, an embodiment of the present disclosure includes a computer program product, which includes a computer program carried on a computer-readable medium, where the computer program includes program code for performing the methods shown in the flowcharts. In such an embodiment, the computer program may be downloaded from a network through the communication apparatus 909 and installed, or installed from the storage apparatus 908, or installed from the ROM 902. When the computer program is executed by the processing apparatus 901, the above-mentioned functions defined in the methods of the embodiments of the present disclosure are performed.

It should be noted that the above-mentioned computer-readable medium described in the present disclosure may be a computer-readable signal medium, or a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read only memory (ROM), an erasable programmable read-only memory (EPROM or flash memory), an optic fiber, a portable compact disk read-only memory (CD-ROM), an optical storage device, a magnetic storage device, or any suitable combination thereof. In the present disclosure, the computer-readable storage medium may be any tangible medium containing or storing a program that may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, RF (radio frequency), etc., or any suitable combination thereof.

The above-mentioned computer-readable medium may be contained in the above-mentioned electronic device. Or, the computer-readable medium may exist independently, without being assembled into the electronic device.

The above-mentioned computer-readable medium carries one or more programs, and when the one or more programs are executed by the electronic device, the electronic device is caused to execute the methods shown in the above embodiments.

The computer program code for performing the operations in the present disclosure may be written in one or more programming languages or a combination thereof, where the programming languages include an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving the remote computer, the remote computer may be connected to the computer of the user over any type of network, including a local area network (LAN) or a wide area network (WAN), or may be connected to an external computer (for example, connected over the Internet using an Internet service provider).

The flowcharts and block diagrams in the accompanying drawings illustrate architectures, functions, and operations of the possible implementations of the systems, methods, and computer program products according to various embodiments of the present disclosure. In this regard, each block in the flowcharts or block diagrams may represent a module, program segment, or part of code, and the module, program segment, or part of code contains one or more executable instructions for implementing the specified logical functions. It should also be noted that in some alternative implementations, the functions marked in the blocks may also occur in an order different from that marked in the accompanying drawings. For example, two blocks shown in succession may actually be executed substantially in parallel, or they may sometimes be executed in the reverse order, depending on the functions involved. It should also be noted that each block in the block diagrams and/or the flowcharts, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by means of software, or may be implemented by means of hardware. The name of a unit does not constitute a limitation on the unit itself in some cases. For example, a first acquiring unit may also be described as “a unit for acquiring at least two Internet Protocol addresses”.

The functions described herein above may be performed at least partially by one or more hardware logic components. For example, without limitation, exemplary types of hardware logic components that may be used include: a field programmable gate array (FPGA), an application specific integrated circuit (ASIC), application specific standard parts (ASSP), a system on chip (SOC), a complex programmable logic device (CPLD), etc.

In the context of the present disclosure, a machine-readable medium may be any tangible medium that may contain or store a program for use by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. More specific examples of the machine-readable storage medium may include an electrical connection based on one or more wires, a portable computer disk, a hard disk, a random access memory (RAM), a read only memory (ROM), an erasable programmable read only memory (EPROM or flash memory), an optic fiber, a portable compact disk read-only memory (CD-ROM), an optical storage device, a magnetic storage device, or any suitable combination thereof.

In a first aspect, according to one or more embodiments of the present disclosure, a data query method is provided. The method includes: displaying a data query statement inputted by a user, where the data query statement includes at least one expression field, and the expression field includes a first object field and a second object field that are arranged in sequence, the first object field representing a data object, and the second object field representing a data attribute of the data object, where the expression field is used to define a data query dimension of a target business process, and the query statement is used to represent a target query dimension formed by at least one data query dimension; and responding to the data query statement to obtain target data, where the target data is a result of querying business node data of the target business process based on the target query dimension.

According to one or more embodiments of the present disclosure, the second object field includes an attribute type field and an attribute value field. The attribute type field represents a type of the data attribute, the attribute value field represents an attribute value of the data attribute of a corresponding type, and the attribute type field is connected to the attribute value field through a second connection field.

According to one or more embodiments of the present disclosure, the first object field is connected to the second object field through a first connection field, and the displaying the data query statement inputted by the user includes: receiving and displaying a first object field inputted by the user; in response to a first connection field inputted by the user, displaying at least one second object field corresponding to the first connection field: and in response to a selection instruction inputted by the user, displaying a target second object field corresponding to the first connection field.

According to one or more embodiments of the present disclosure, the data query statement further includes a logical connection field, and the logical connection field represents an intersection operation or a union operation of the data query dimension corresponding to the expression field.

According to one or more embodiments of the present disclosure, the responding to the data query statement to obtain the target data includes: acquiring an object data model, where the object data model is used to store data of business nodes of the target business process; and inputting the data query statement into the object data model to obtain the target data.

According to one or more embodiments of the present disclosure, the inputting the data query statement into the object data model to obtain the target data includes: parsing the data query statement to obtain the data object corresponding to each expression field and the data attribute of the data object: and searching the object data model based on the data object corresponding to each expression field and the data attribute of the data object, to obtain the target data, where the object data model is constructed based on a first data structure, and the first data structure is a tree structure representing a mapping relationship between a data object and a data attribute.

According to one or more embodiments of the present disclosure, the parsing the data query statement to obtain the data object corresponding to each expression field and the data attribute of the data object includes: performing syntax parsing on the data query statement to construct an abstract syntax tree corresponding to the data query statement: performing splitting and grouping aggregation on the abstract syntax tree to generate at least one homogeneous syntax tree, where the homogeneous syntax tree corresponds to at least one target data object and at least two attributes of the target data object: and recombining the at least one homogeneous syntax tree into a target syntax tree, where the target syntax tree includes the data object corresponding to each expression field and the data attribute of the data object.

According to one or more embodiments of the present disclosure, the searching the object data model based on the data object corresponding to each expression field and the data attribute of the data object, to obtain the target data includes: calling a corresponding database statement based on the target syntax tree, and searching the object data model to obtain the target data.

According to one or more embodiments of the present disclosure, the performing splitting and grouping aggregation on the abstract syntax tree to generate at least one homogeneous syntax tree includes: splitting the abstract syntax tree into at least one syntax sub-tree based on each expression field in the data query statement: and performing grouping aggregation on the at least one syntax sub-tree based on a same data object in the at least one syntax sub-tree, to generate at least one homogeneous syntax tree.

According to one or more embodiments of the present disclosure, the performing grouping aggregation on the at least one syntax sub-tree based on the same data object in the at least one syntax sub-tree to generate at least one homogeneous syntax tree includes: labeling an aggregation function in each syntax sub-tree; and replacing the aggregation function with an auxiliary calculation field to generate the homogeneous syntax tree, where the auxiliary calculation field is used to map to an expression of the aggregation function.

According to one or more embodiments of the present disclosure, before inputting the data query statement into the object data model to obtain the target data, the method further includes: determining a data source based on the data query statement, where the data source is business node data in at least one preprocessing dimension: and configuring the object data model based on the data source to obtain a target object data model, where the target object data model is used to store the data source, where the preprocessing dimension includes at least one of the following: data time, a data business type: and inputting the data query statement into the object data model to obtain the target data includes: querying the target object data model based on the data query statement to obtain the target data.

According to one or more embodiments of the present disclosure, after the target data is obtained, the method further includes: performing visualization rendering based on the target data, and displaying a data chart, where the data chart is used to display a target data object corresponding to the target data and a target data attribute corresponding to the target data object.

In a second aspect, according to one or more embodiments of the present disclosure, a data query apparatus is provided. The apparatus includes:
an input module, configured to: display a data query statement inputted by a user, where the data query statement includes at least one expression field, and the expression field includes a first object field and a second object field that are arranged in sequence, the first object field representing a data object, and the second object field representing a data attribute of the data object, where the expression field is used to define a data query dimension of a target business process, and the query statement is used to represent a target query dimension formed by at least one data query dimension: and
a query module, configured to respond to the data query statement to obtain target data, where the target data is a result of querying business node data of the target business process based on the target query dimension.

In an embodiment of the present disclosure, the second object field includes an attribute type field and an attribute value field. The attribute type field represents a type of the data attribute, the attribute value field represents an attribute value of the data attribute of a corresponding type, and the attribute type field is connected to the attribute value field through a second connection field.

In an embodiment of the present disclosure, the first object field is connected to the second object field through a first connection field, and the input module is specifically configured to: receive and display a first object field inputted by the user: in response to a first connection field inputted by the user, display at least one second object field corresponding to the first connection field: and in response to a selection instruction inputted by the user, display a target second object field corresponding to the first connection field.

In an embodiment of the present disclosure, the data query statement further includes a logical connection field, and the logical connection field represents an intersection operation or a union operation of the data query dimension corresponding to the expression field.

In an embodiment of the present disclosure, the query module is specifically configured to: acquire an object data model, where the object data model is used to store data of business nodes of the target business process; and input the data query statement into the object data model to obtain the target data.

In an embodiment of the present disclosure, when inputting the data query statement into the object data model to obtain the target data, the query module is specifically configured to: parse the data query statement to obtain the data object corresponding to each expression field and the data attribute of the data object; and search the object data model based on the data object corresponding to each expression field and the data attribute of the data object, to obtain the target data, where the object data model is constructed based on a first data structure, and the first data structure is a tree structure representing a mapping relationship between a data object and a data attribute.

According to one or more embodiments of the present disclosure, when parsing the data query statement to obtain the data object corresponding to each expression field and the data attribute of the data object, the query module is specifically configured to: perform syntax parsing on the data query statement to construct an abstract syntax tree corresponding to the data query statement: perform splitting and grouping aggregation on the abstract syntax tree to generate at least one homogeneous syntax tree, where the homogeneous syntax tree corresponds to at least one target data object and at least two attributes of the target data object; and recombine the at least one homogeneous syntax tree into a target syntax tree, where the target syntax tree includes the data object corresponding to each expression field and the data attribute of the data object.

According to one or more embodiments of the present disclosure, when searching the object data model based on the data object corresponding to each expression field and the data attribute of the data object, to obtain the target data, the query module is specifically configured to: call a corresponding database statement based on the target syntax tree, and search the object data model to obtain the target data.

According to one or more embodiments of the present disclosure, when performing splitting and grouping aggregation on the abstract syntax tree to generate at least one homogeneous syntax tree, the query module is specifically configured to: split the abstract syntax tree into at least one syntax sub-tree based on each expression field in the data query statement; and perform grouping aggregation on the at least one syntax sub-tree based on a same data object in the at least one syntax sub-tree, to generate at least one homogeneous syntax tree.

According to one or more embodiments of the present disclosure, when performing grouping aggregation on the at least one syntax sub-tree based on the same data object in the at least one syntax sub-tree to generate at least one homogeneous syntax tree, the query module is specifically configured to: label an aggregation function in each syntax sub-tree: and replace the aggregation function with an auxiliary calculation field to generate the homogeneous syntax tree, where the auxiliary calculation field is used to map to an expression of the aggregation function.

According to one or more embodiments of the present disclosure, before inputting the data query statement into the object data model to obtain the target data, the input module is further configured to: determine a data source based on the data query statement, where the data source is business node data in at least one preprocessing dimension: and configure the object data model based on the data source to obtain a target object data model, where the target object data model is used to store the data source, where the preprocessing dimension includes at least one of the following: data time, a data business type: and the query module is specifically configured to: query the target object data model based on the data query statement to obtain the target data.

According to one or more embodiments of the present disclosure, after the target data is obtained, the query module is further configured to: perform visualization rendering based on the target data, and display a data chart, where the data chart is used to display a target data object corresponding to the target data and a target data attribute corresponding to the target data object.

In a third aspect, according to one or more embodiments of the present disclosure, an electronic device is provided. The electronic device includes: a processor and a memory communicatively connected to the processor:
the memory stores computer-execution instructions; and
the processor executes the computer-execution instructions stored in the memory to implement the data query method according to the first aspect and various possible designs of the first aspect described above.

In a fourth aspect, according to one or more embodiments of the present disclosure, a computer-readable storage medium is provided. The computer-readable storage medium stores computer-execution instructions. When a processor executes the computer-executable instructions, the data query method according to the first aspect and various possible designs of the first aspect described above is implemented.

In a fifth aspect, an embodiment of the present disclosure provides a computer program product, including a computer program. When the computer program is executed by a processor, the data query method according to the first aspect and various possible designs of the first aspect described above is implemented.

In a sixth aspect, an embodiment of the present disclosure provides a computer program. When the computer program is executed by a processor, the data query method according to the first aspect and various possible designs of the first aspect described above is implemented.

In the data query method and apparatus, the electronic device, and the storage medium provided in the embodiments, a data query statement inputted by a user is displayed, where the data query statement includes at least one expression field, and the expression field includes a first object field and a second object field that are arranged in sequence, the first object field representing a data object, and the second object field representing a data attribute of the data object, where the expression field is used to define a data query dimension of a target business process, and the query statement is used to represent a target query dimension formed by at least one data query dimension: and target data is obtained by responding to the data query statement, where the target data is a result of querying business node data of the target business process based on the target query dimension. Through parsing the data query statement inputted by the user, the data query dimension is represented by a combination representation of the data object and the data attribute, and then the target query dimension is obtained based on a combination of a plurality of data query dimensions. Query is then performed on the business node data in the target business process for the target query dimension, to obtain the corresponding target data, thereby realizing flexible search based on a user instruction, and improving efficient search for business node data in a combined dimension in the business process.

The foregoing descriptions are merely preferred embodiments of the present disclosure and explanations of the applied technical principles. Persons skilled in the art should understand that the scope of disclosure involved in the present disclosure is not limited to the technical solutions formed by the specific combinations of the foregoing technical features, and shall also cover other technical solutions formed by any combination of the foregoing technical features or equivalent features thereof without departing from the foregoing concept of disclosure, for example, the technical solution formed by replacing the foregoing features and technical features with similar functions as disclosed in the present disclosure (but not limited thereto) with each other.

In addition, although various operations are depicted in a specific order, it should not be understood as requiring these operations to be performed in the specific order shown or in a sequential order. Under specific circumstances, multitasking and parallel processing may be advantageous. Similarly, although several specific implementation details are included in the foregoing discussions, these details should not be construed as limiting the scope of the present disclosure. Some features that are described in the context of separate embodiments may also be implemented in combination in a single embodiment. In contrast, various features described in the context of a single embodiment may also be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A data query method, comprising:
displaying a data query statement inputted by a user, wherein the data query statement comprises at least one expression field, and the expression field comprises a first object field and a second object field that are arranged in sequence, the first object field representing a data object, and the second object field representing a data attribute of the data object, where the expression field is used to define a data query dimension of a target business process, and the query statement is used to represent a target query dimension formed by at least one data query dimension; and
responding to the data query statement to obtain target data, wherein the target data is a result of querying business node data of the target business process based on the target query dimension.

2. The method according to claim 1, wherein the second object field comprises an attribute type field and an attribute value field; where the attribute type field represents a type of the data attribute, the attribute value field represents an attribute value of the data attribute of a corresponding type, and the attribute type field is connected to the attribute value field through a second connection field.

3. The method according to claim 1, wherein the first object field is connected to the second object field through a first connection field, and the displaying the data query statement inputted by the user comprises:
receiving and displaying a first object field inputted by the user;
in response to a first connection field inputted by the user, displaying at least one second object field corresponding to the first connection field; and
in response to a selection instruction inputted by the user, displaying a target second object field corresponding to the first connection field.

4. The method according to claim 1, wherein the data query statement further comprises a logical connection field, and the logical connection field represents an intersection operation or a union operation of the data query dimension corresponding to the expression field.

5. The method according to claim 1, wherein the responding to the data query statement to obtain the target data comprises:
acquiring an object data model, wherein the object data model is used to store data of business nodes of the target business process; and
inputting the data query statement into the object data model to obtain the target data.

6. The method according to claim 5, wherein the inputting the data query statement into the object data model to obtain the target data comprises:
parsing the data query statement to obtain the data object corresponding to each expression field and the data attribute of the data object; and
searching the object data model based on the data object corresponding to each expression field and the data attribute of the data object, to obtain the target data, wherein the object data model is constructed based on a first data structure, and the first data structure is a tree structure representing a mapping relationship between a data object and a data attribute.

7. The method according to claim 6, wherein the parsing the data query statement to obtain the data object corresponding to each expression field and the data attribute of the data object comprises:
performing syntax parsing on the data query statement to construct an abstract syntax tree corresponding to the data query statement;
performing splitting and grouping aggregation on the abstract syntax tree to generate at least one homogeneous syntax tree, wherein the homogeneous syntax tree corresponds to at least one target data object and at least two attributes of the target data object; and
recombining the at least one homogeneous syntax tree into a target syntax tree, wherein the target syntax tree comprises the data object corresponding to each expression field and the data attribute of the data object.

8. The method according to claim 7, wherein the searching the object data model based on the data object corresponding to each expression field and the data attribute of the data object, to obtain the target data comprises:
calling a corresponding database statement based on the target syntax tree, and searching the object data model to obtain the target data.

9. The method according to claim 7, wherein the performing splitting and grouping aggregation on the abstract syntax tree to generate at least one homogeneous syntax tree comprises:
splitting the abstract syntax tree into at least one syntax sub-tree based on each expression field in the data query statement; and
performing grouping aggregation on the at least one syntax sub-tree based on a same data object in the at least one syntax sub-tree, to generate at least one homogeneous syntax tree.

10. The method according to claim 5, wherein before inputting the data query statement into the object data model to obtain the target data, the method further comprises:
determining a data source based on the data query statement, wherein the data source is business node data in at least one preprocessing dimension; and
configuring the object data model based on the data source to obtain a target object data model, wherein the target object data model is used to store the data source, wherein the preprocessing dimension comprises at least one of the following: data time, a data business type; and
the inputting the data query statement into the object data model to obtain the target data comprises:
inputting the data query statement into the target object data model to obtain the target data.

11. The method according to claim 1, wherein after the target data is obtained, the method further comprises:
performing visualization rendering based on the target data, and displaying a data chart, wherein the data chart is used to display a target data object corresponding to the target data and a target data attribute corresponding to the target data object.

12. (canceled)

13. An electronic device, comprising: a processor and a memory communicatively connected to the processor;
the memory stores computer-execution instructions; and
when the processor executes the computer-execution instructions stored in the memory, the processor is enabled to:
display a data query statement inputted by a user, wherein the data query statement comprises at least one expression field, and the expression field comprises a first object field and a second object field that are arranged in sequence, the first object field representing a data object, and the second object field representing a data attribute of the data object, where the expression field is used to define a data query dimension of a target business process, and the query statement is used to represent a target query dimension formed by at least one data query dimension; and
respond to the data query statement to obtain target data, wherein the target data is a result of querying business node data of the target business process based on the target query dimension.

14. A non-transitory computer-readable storage medium, wherein the computer-readable storage medium stores computer-execution instructions, and when a processor executes the computer-execution instructions, the following operations are implemented:
displaying a data query statement inputted by a user, wherein the data query statement comprises at least one expression field, and the expression field comprises a first object field and a second object field that are arranged in sequence, the first object field representing a data object, and the second object field representing a data attribute of the data object, where the expression field is used to define a data query dimension of a target business process, and the query statement is used to represent a target query dimension formed by at least one data query dimension; and
responding to the data query statement to obtain target data, wherein the target data is a result of querying business node data of the target business process based on the target query dimension.

15-16. (canceled)

17. The electronic device according to claim 13, wherein the second object field comprises an attribute type field and an attribute value field; where the attribute type field represents a type of the data attribute, the attribute value field represents an attribute value of the data attribute of a corresponding type, and the attribute type field is connected to the attribute value field through a second connection field.

18. The electronic device according to claim 13, wherein the first object field is connected to the second object field through a first connection field, and the processor is enabled to:
receive and displaying a first object field inputted by the user;
in response to a first connection field inputted by the user, display at least one second object field corresponding to the first connection field; and
in response to a selection instruction inputted by the user, display a target second object field corresponding to the first connection field.

19. The electronic device according to claim 13, wherein the data query statement further comprises a logical connection field, and the logical connection field represents an intersection operation or a union operation of the data query dimension corresponding to the expression field.

20. The electronic device according to claim 13, wherein the processor is further enabled to:
acquire an object data model, wherein the object data model is used to store data of business nodes of the target business process; and
input the data query statement into the object data model to obtain the target data.

21. The electronic device according to claim 20, wherein the processor is further enabled to:
parse the data query statement to obtain the data object corresponding to each expression field and the data attribute of the data object; and
search the object data model based on the data object corresponding to each expression field and the data attribute of the data object, to obtain the target data, wherein the object data model is constructed based on a first data structure, and the first data structure is a tree structure representing a mapping relationship between a data object and a data attribute.

22. The electronic device according to claim 21, wherein the processor is further enabled to:
perform syntax parsing on the data query statement to construct an abstract syntax tree corresponding to the data query statement;
perform splitting and grouping aggregation on the abstract syntax tree to generate at least one homogeneous syntax tree, wherein the homogeneous syntax tree corresponds to at least one target data object and at least two attributes of the target data object; and
recombine the at least one homogeneous syntax tree into a target syntax tree, wherein the target syntax tree comprises the data object corresponding to each expression field and the data attribute of the data object.

23. The electronic device according to claim 22, wherein the processor is further enabled to:
call a corresponding database statement based on the target syntax tree, and searching the object data model to obtain the target data.
